(19) United States
(12) Patent Application Publication
(10) Pub. No.: US 2020/0291720 A1
(43) Pub. Date: Sep. 17, 2020

(54) INSECT SCREEN ASSEMBLY

(71) Applicant: GENNISSEN IP B.V., Alblasserdam (NL)

(72) Inventor: Eduardus Leonardus GENNISSEN, Nieuw Lekkerland (NL)

(21) Appl. No.: 16/306,388

(22) PCT Filed: Jun. 2, 2017
(86) PCT No.: PCT/NL2017/050360

§ 371 Date: Nov. 30, 2018

(30) Foreign Application Priority Data
Jun. 3, 2016 (NL) 2016894
Jun. 10, 2016 (NL) 2016942

(51) Int. Cl. E06B 9/52; A01M 29/34; E06B 9/262; E04H 1/12

(52) U.S. Cl. CPC E06B 9/52; A01M 29/34; E06B 9/262; E06B 2009/527; E06B 2009/2627; E06B 2009/524; E04H 1/1205

(57) ABSTRACT

The invention relates a covering assembly, such as an insect screen assembly, for a living space, a door or window, e.g. of a vehicle. The assembly includes an assembly frame and at least one movable beam, movable with respect to the assembly frame. The assembly includes a covering connected to the at least one movable beam, so as to be moved between a first and a second position. The covering includes a honeycomb covering.

### FIELD OF THE INVENTION

The present invention relates to the field of insect screens, such as mosquito nets. More in general the invention relates to insect screen assemblies and insect screen units. The invention also relates to door or window covering assemblies. More in particular the invention relates to insect screen assemblies, such as sliding screen assemblies. The invention also relates to door or window covering assemblies, e.g. for vehicles.

### BACKGROUND TO THE INVENTION

Mosquito nets are known per se. Most often, a net of a mesh material is suspended from a ceiling and draped around an area to be protected against insects, such as a bed or a table and chairs. An entrance is often provided by overlapping two adjacent flaps of net. Sometimes, an entrance is provided in the form of a zipper. The known mosquito nets are often perceived as cumbersome.

Vehicles, such as recreational vehicles, are normally provided with one or more doors and/or one or more windows. Often it is desired to provide the door and/or the window with a window covering. The window covering may e.g. include an insect screen. Alternatively, or additionally, the window covering can include a shade or a blackout. A blackout generally refers to a shade having light transmissivity of zero or close to zero.

The insect screen can be a pleated screen. To provide the insect screen with rigidity often cords are threaded through holes in the pleated screen. This can be time-consuming in manufacture. Also, the cords may be subject to wear.

### SUMMARY OF THE INVENTION

The invention relates to an insect screen assembly. The insect screen assembly can be an insect screen assembly for a door frame or a window frame, e.g. of a vehicle. The invention also relates to a covering assembly. The covering assembly can be a covering assembly for a door frame or a window frame, e.g. of a vehicle.

An object of the invention is to provide an insect screen assembly which can easily be assembled. Another object of the invention is to provide an improved insect screen for a window frame or a door frame, e.g. of a vehicle. Another object of the invention is to provide an alternative insect screen assembly for a window frame or a door frame, e.g. of a vehicle. An object of the invention is to provide a covering assembly which can easily be assembled. Another object of the invention is to provide an improved covering assembly for a window frame or a door frame, e.g. of a vehicle. Another object of the invention is to provide an alternative covering assembly for a window frame or a door frame, e.g. of a vehicle. Another object of the invention is to provide an insect screen unit that can be used to shield a living area such as a bed, chair and/or table from insects. The insect screen unit can include an insect screen assembly according to the invention. Another object of the invention is to provide a covering unit that can be used to shield a living area such as a bed, chair and/or table.

Thereto according to an aspect is provided an insect screen assembly. The insect screen assembly can be an insect screen assembly for a door or window, e.g. of a vehicle. The insect screen assembly includes an assembly frame. The assembly frame can e.g. be rectangular. The assembly frame can be mounted to a door frame or window frame, or to a wall surrounding the door frame or window frame. The door or window can e.g. be in a side wall or a roof. The assembly frame can also be placed in a space such as free-standing and/or offset relative to a wall. The insect screen assembly includes at least one movable beam, movable with respect to the assembly frame. The movable beam can e.g. be positioned substantially vertically in a door opening, or e.g. substantially vertically or substantially horizontally in a window opening. The insect screen assembly includes a screen connected to the at least one movable beam, so as to be moved between a first and a second position. The first position can be an open position. The second position can be a closed position. In the open position the screen can be folded to one side so as to provide a free opening through the assembly frame, and hence through the door or window. In the closed position the screen can extend over the entire area of the door or window opening so as to provide insect protection. The screen includes a honeycomb screen. The honeycomb screen can include one or more rows of, substantially, tubular cells. The tubular cells can extend in a direction in the plane in which the screen extend, i.e. orthogonal to a thickness direction of the screen. The honeycomb screen can include a first screen, such as an outer screen, a second screen, such as an inner screen, and a plurality of transverse connections, such as sheets, connecting the inner and the outer screens. The transverse sheets can be screens as well. However, the honeycomb screen can be manufactured differently as well. For example, each substantially tubular screen of the honeycomb screen can be made from a separate sheet of screen.

The screen including a honeycomb screen provides the advantage that the honeycomb screen can be stiffer than a pleated screen or a straight roll-up screen. This provides the advantage that the insect screen assembly can be more rugged in use. Moreover, since the honeycomb screen is stiff, it resists deformation. Hence, cords extending through the screen, e.g. threaded through holes in the screen surface, can be omitted. Hence the screen assembly can be free from cords extending through the screen, such as through holes in the screen surface. As a result, assembly of the screen assembly is simplified. Moreover, omitting holes in the screen surface for feeding through a cord can prevent insects from entering through those holes. Optionally, the entire screen is a honeycomb screen.

Optionally, the assembly frame includes two opposed guides. The opposed guides can guide the at least one movable beam. The assembly frame can include cords extending through the movable beam, e.g. in a so-called H-configuration, for preventing the movable beam from slanting.

Optionally, one or each of the two opposed guides is arranged for guiding the screen. For example one or each of the two opposed guides includes a groove for guiding the screen. Hence the screen can be tucked into the grooves allowing proper guidance of the screen and good sealing against insects.

Optionally, the insect screen assembly includes one or more stiffening ribs. The stiffening ribs can be used for stiffening the screen. Hence, the screen can be made even stiffer. The stiffening ribs can be rods, tubes, beams, extrusions or the like. Optionally, the one or more stiffening ribs are inserted in cells of the honeycomb screen. The cells can be formed between the first screen, the second screen and two transverse connections, such as transverse sheets. The stiffening ribs can be used instead of tensioning cords extending through the screen, e.g. threaded through holes in the screen surface. However, the stiffening ribs can be used in combination with tensioning cords extending through the screen, e.g. threaded through holes in the screen surface. The insect screen assembly can also be provided with tensioning cords extending through the screen, e.g. threaded through holes in the screen surface, instead of stiffening ribs.

Optionally, the one or more stiffening ribs are guided by at least one of the two opposed guides. The one or more stiffening ribs can e.g. be guided in grooves formed in the opposed guides. This provides the advantage that the screen is even more securely guided by the opposed guides. Further, stiffness and/or ruggedness of the screen is improved.

Optionally, the two opposed guides are curved. The opposed guides can be curved in a direction substantially orthogonal to a length direction of the movable beam. An axis (or axes) around which the movable guides form a curve can be substantially parallel to a length direction of the movable beam. Hence, the insect screen assembly can be fit to a curved window or door. The stiffening ribs, especially when guided by the opposed guides ensure proper curving of the entire screen, and following of the curve during opening and closing of the screen. The stiffening ribs being inserted into cells of the honeycomb screen allow for a very simple and robust solution for the curved screen.

Optionally, the movable beam is curved. Also frame members substantially parallel with the movable beam can be curved. An axis (or axes) around which the movable beam forms a curve can be substantially parallel to a movement direction of the movable beam. The stiffening ribs can be curved, e.g. conforming to the curved movable beam.

Optionally, the insect screen is double curved. The double curvature can be composed of two curvatures around mutually orthogonal axes. The opposed guides can be curved and the movable beam can be curved.

Optionally, the insect screen assembly further includes a shade or blind connected to the moveable beam. Optionally, the insect screen assembly further includes a blackout connected to the moveable beam. The screen can be connected to a first side of the movable beam. The shade or blackout can be connected to a second, opposite, side of the movable beam. Hence moving of the movable beam allows for total or partial choice between insect screen and shade. It will be appreciated that the first position may correspond to the screen being fully expanded, and the second position may correspond to the shade being fully expanded. It is also possible that the screen and the shade or blackout each are associated with a dedicated movable beam. It is also possible that the assembly includes two screens or two shades.

Optionally, the shade includes a honeycomb shade.

Optionally, the blackout includes a honeycomb blackout.

Optionally, the door or window frame and assembly frame are substantially rectangular. However, it is also possible that the assembly frame includes frame members that are slanted. It is also possible that one or more of the frame members is curved. Optionally, the assembly frame includes a frame member that is bent to form a rounded corner of the assembly frame. Optionally the assembly frame includes a single frame member bent to form the whole, or substantially the whole, perimeter of the assembly frame. Optionally at least one corner of the assembly frame is rounded.

Optionally the screen and/or shade and/or blackout is fire retardant or fire resistant.

According to an aspect is provided an insect screen unit including one or more walls for forming a closed enclosure, at least one of the walls including a screen door. The screen door can be formed by a part of the wall. Alternatively, the entire wall can form the screen door. The screen door includes an assembly frame and at least one movable beam, movable with respect to the assembly frame. A screen is connected to the at least one movable beam, so as to be moved between a first and a second position. The insect screen unit can e.g. be sized and/or shaped to house a bed, one or more chairs and/or a table. Hence, the insect screen unit provides a closed enclosure sealed against insects. The one or more walls are arranged for forming a closed enclosure by themselves or in cooperation with one or more pre-existing walls. The insect screen unit can be arranged to be free-standing. Then the walls must provide 360° covering to provide the closed enclosure. The insect screen unit can be arranged to be positioned against, or attached to, a pre-existing wall or walls, such as against two pre-existing walls forming a corner. Then the pre-existing wall(s) can cooperate in forming the closed enclosure. The insect screen unit can include at least two walls. The insect screen unit can include at least three walls. The insect screen unit can include at least four walls. The insect screen unit can include at least five walls. One of the walls may be a roof.

Optionally, the screen includes a honeycomb screen. It will be appreciated that the honeycomb screen prevents excellent protection against insect stings or bites. The presence of the cells of the honeycomb keeps the insect at a distance even if one's skin touches the other side of the honeycomb screen.

Optionally, the screen material is provided with a heat reflecting coating. The heat reflecting coating can e.g. be a metal coating, such as an aluminium coating. The metal coating can be applied by deposition. It is possible that the heat reflecting coating is applied solely to the outer side of the screen.

Optionally, the assembly frame includes one guide, or two opposed guides. Optionally, the one guide or one or each of the two opposed guides is arranged for guiding the screen.

Optionally, the insect screen unit includes one or more cords for stiffening the screen. Optionally, the insect screen unit includes one or more stiffening ribs for stiffening the screen. The screen of the door can be stiffened. Also, other walls of the insect screen unit can include screen material, and can be stiffened. Optionally, the one or more stiffening ribs are inserted in cells of the honeycomb screen.

Optionally, the one or more stiffening ribs are guided by the one guide or at least one of the two opposed guides.

Optionally, the screen door is curved. Optionally, the two opposed guides are curved. Optionally, the movable beam is curved. Optionally, the ribs are curved. Optionally, the screen door is double curved.

According to an aspect is provided an enclosing unit including one or more walls for forming a closed enclosure, at least one of the walls including a door including an assembly frame at least one movable beam, movable with respect to the assembly frame, and a sheet connected to the at least one movable beam, so as to be moved between a first and a second position.

Optionally, any wall can be made of, or include, a screen, a sheet ( e.g. a transparent sheet), a watertight sheet, a shade and/or a blackout, or combinations thereof.

Optionally, the enclosing unit is designed as a blackout unit. The walls of the blackout unit can include blackout material. For example most walls of the blackout unit are made of, or include, blackout material. The blackout unit can e.g. form a closed enclosure substantially sealed against ambient light. The blackout unit can be sized and/or shaped to house a bed, e.g. for persons that want to, or have to, sleep during daylight hours.

The enclosing unit and/or the insect screen unit can be arranged to be positioned on a vehicle, such as a bus, e.g. a tour bus or safari bus. The enclosing unit and/or the insect screen unit can be arranged to be positioned on a vessel, such as a yacht.

The enclosing unit and/or the insect screen unit can include an air conditioning unit. It will be appreciated that conditioning the air inside the enclosing unit and/or the insect screen unit can require less energy than conditioning the air inside an entire rom or entire house. For example, when the enclosing unit and/or the insect screen unit is arranged for housing a bed, only the space within the enclosing unit and/or the insect screen unit needs to be conditioned during bed time.

According to an aspect is provided a covering assembly. The covering assembly can be a covering assembly for a door or window, e.g. of a vehicle. The covering assembly includes an assembly frame and at least one movable beam, movable with respect to the assembly frame. The covering assembly includes a covering connected to the at least one movable beam, so as to be moved between a first and a second position. The first position can be an open position. The second position can be a closed position. The covering includes a honeycomb covering. The honeycomb covering can include an first sheet, an second sheet and a plurality of transverse sheets connecting the first and the second sheets. The honeycomb covering can include one or more rows of tubular cells.

Optionally, the assembly frame includes two opposed guides. The opposed guides can be arranged for guiding the at least one movable beam.

Optionally, one or each of the two opposed guides is arranged for guiding the covering. Optionally, one or each of the two opposed guides includes a groove for guiding the covering.

Optionally, the covering assembly includes one or more stiffening ribs. The stiffening ribs can be used for stiffening the covering. The stiffening ribs can be rods, tubes, beams, extrusions or the like. Optionally, the one or more stiffening ribs are inserted in cells of the honeycomb covering. The cells can be formed between the first sheet, the second sheet and two transverse sheets. The stiffening ribs can be used instead of tensioning cords extending through the covering, e.g. threaded through holes in the covering surface. However, the stiffening ribs can be used in combination with tensioning cords extending through the covering, e.g. threaded through holes in the covering surface.

Optionally, the one or more stiffening ribs are guided by at least one of the two opposed guides. The one or more stiffening ribs can e.g. be guided in grooves formed in the opposed guides. This provides the advantage that the covering is even more securely guided by the opposed guides. Further, stiffness and/or ruggedness of the covering is improved.

Optionally, the two opposed guides are curved. The opposed guides can be curved in a direction substantially orthogonal to a length direction of the movable beam. Hence, the covering assembly can be fit to a curved window or door. The stiffening ribs, especially when guided by the opposed guides ensure proper curving of the entire covering, and following of the curve during opening and closing of the covering. The stiffening ribs being inserted into cells of the honeycomb covering allow for a very simple and robust solution for the curved covering.

Optionally, the movable beam is curved. Also frame members substantially parallel with the movable beam can be curved. An axis (or axes) around which the movable beam forms a curve can be substantially parallel to a movement direction of the movable beam. The stiffening ribs can be curved, e.g. conforming to the curved movable beam.

Optionally, the covering or insect screen is double curved. The double curvature can be composed of two curvatures around mutually orthogonal axes. The opposed guides can be curved and the movable beam can be curved.

Optionally, the covering includes, or is, a honeycomb insect screen.

Optionally, the covering includes, or is, a honeycomb shade.

Optionally, the covering includes, or is, a honeycomb blackout.

Optionally, the covering assembly includes a honeycomb insect screen connected to a first side of the moveable beam, and a honeycomb shade or blackout connected to a second side of the moveable beam.

Optionally, the covering assembly includes at least two movable beams. Each beam can have a screen, shade or blackout connected thereto. It is also possible that a screen, shade or blackout is connected to two movable beams and extends in between said two movable beams.

According to an aspect is provided a covering assembly including a honeycomb covering including a plurality of, substantially, tubular cells, and one or more stiffening ribs. The covering assembly may be a covering assembly for a door or a window. The covering can e.g. be a screen, a shade and/or a blackout. The stiffening ribs increase ruggedness of the covering assembly. The covering assembly can e.g. be hung in front of a window. The substantially tubular cells can e.g. extend substantially horizontally.

Optionally, the one or more stiffening ribs are inserted in the substantially tubular cells. Hence, the stiffening ribs are easily incorporated in the assembly. Optionally, at least one of the stiffening ribs is placed spaced away from an edge of the honeycomb covering. At least one of the stiffening ribs can e.g. be inserted in a substantially tubular cell that is spaced from the substantially tubular cells at the edge of the honeycomb covering. Hence, such stiffening rib provides stiffening of the honeycomb covering at a position spaced from the edge, e.g. near a center of the honeycomb covering.

According to an aspect is provided a curved covering assembly. The curved covering assembly can e.g. be a curved covering assembly for a curved door or curved window, e.g. of a vehicle, e.g. for a curved door frame or window frame. The curved covering assembly includes a curved assembly frame and at least one movable beam, movable with respect to the assembly frame. The curved covering assembly includes a covering connected to the at least one movable beam, so as to be moved between a first and a second position. The curved covering assembly includes one or more stiffening ribs associated with the covering.

Optionally, the covering includes a honeycomb covering. The honeycomb covering can include a first sheet, an second sheet and a plurality of transverse sheets connecting the first and the second sheets. The honeycomb covering can include one or more rows of tubular cells. The curved covering assembly includes one or more stiffening ribs guided by the opposed curved guides. Optionally, the one or more stiffening ribs are inserted in cells of the honeycomb covering. The cells can be formed between the inner sheet, the outer sheet and two transverse sheets.

Optionally, the curved covering assembly includes at least one guide for guiding the movable beam. Optionally, the at least one guide is curved. Alternatively, or additionally, the movable beam can be curved. Optionally, the one or more stiffening ribs are curved.

According to an aspect is provided use of a honeycomb screen in an insect screen assembly, e.g. for a door or window, e.g. of a vehicle. According to an aspect is provided use of a combination of a honeycomb covering and one or more stiffening ribs in a covering assembly, e.g. for a door or window, e.g. of a vehicle. Optionally, the stiffening ribs are inserted in substantially tubular cells of the honeycomb covering. Optionally, at least one stiffening rib is inserted in a substantially tubular cell that is spaced relative to a substantially tubular cell at an edge of the honeycomb covering.

It will be appreciated that the honeycomb screen prevents excellent protection against insect stings or bites. The presence of the cells of the honeycomb keeps the insect at a distance even if one's skin touches the other side of the honeycomb screen. It is also possible that the honeycomb screen is used in an insect screen assembly comprising a sheet of honeycomb screen having one or more attachment points arranged to be suspended therefrom (e.g. from a ceiling), wherein the sheet is arranged to enclose a space, e.g. housing a bed. The suspended insect screen assembly can include a door formed by one part of the honeycomb screen overlapping another part of the honeycomb screen.

According to an aspect is provided use of a honeycomb covering in a curved covering assembly, e.g. for a door or window, e.g. of a vehicle.

It will be appreciated that any of the aspects, features and options described in view of the insect screen assembly apply equally to the covering assemblies, the curved covering assembly, insect screen unit, covering unit, and the uses, and vice versa. It will also be clear that any one or more of the above aspects, features and options can be combined.

### BRIEF DESCRIPTION OF THE DRAWINGS

The invention will further be elucidated on the basis of exemplary embodiments which are represented in a drawing. The exemplary embodiments are given by way of non-limitative illustration. It is noted that the figures are only schematic representations of embodiments of the invention that are given by way of non-limiting example.

In the drawing:

FIG. 1A shows a schematic representation of an insect screen assembly,

FIG. 1B shows a schematic representation of a honeycomb covering,

FIG. 1C shows a schematic representation of a honeycomb covering,

FIG. 2 shows a schematic representation of part of an insect screen assembly,

FIG. 3A shows a schematic representation of a curved covering assembly,

FIG. 3B shows a schematic representation of a curved covering assembly,

FIG. 4A shows a schematic representation of an insect screen unit,

FIG. 4B shows a schematic representation of a door,

FIG. 5 shows a schematic representation of an insect screen unit,

FIG. 6 shows a schematic representation of an insect screen unit,

FIGS. 7a-7d show schematic representations of insect screen units,

FIG. 8 shows a schematic representation of an insect screen unit, and

FIG. 9 shows a schematic representation of an insect screen unit.

### DETAILED DESCRIPTION

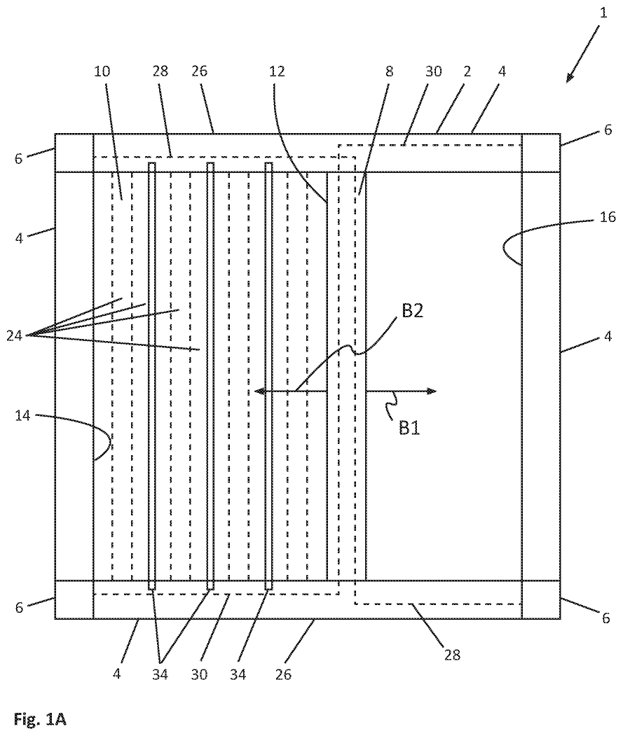

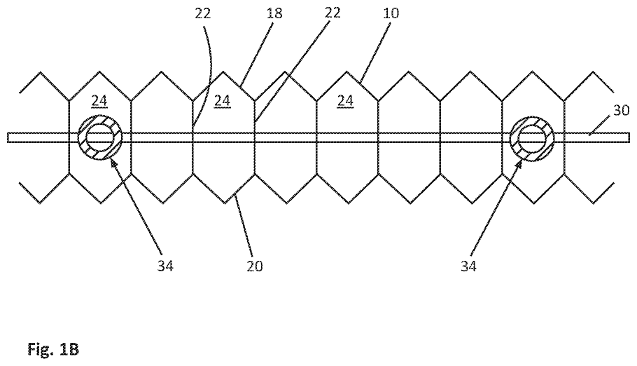

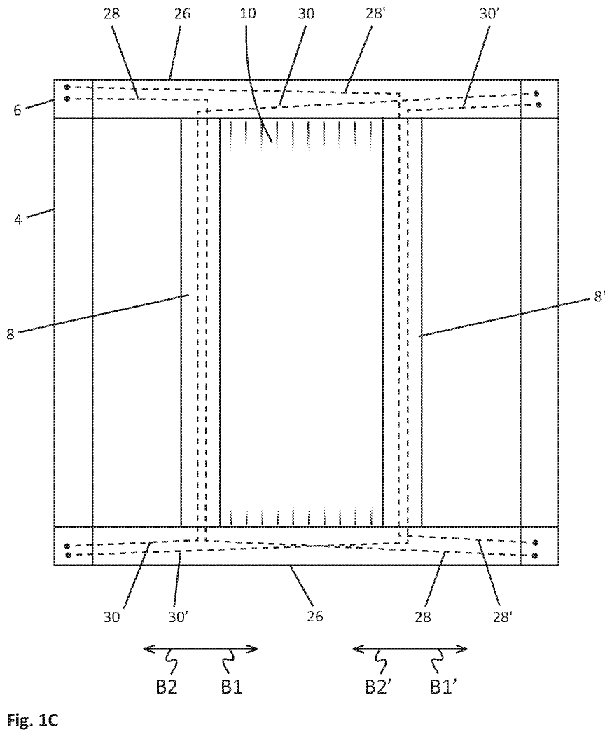

FIG. 1A shows a schematic representation of an insect screen assembly 1. The insect screen assembly 1 can be mountable to a door frame or window frame, or to a wall adjacent a door frame or window frame. The insect screen assembly 1 can also be positioned in a space, e.g. free-standing and/or offset relative to a wall. The door or window can e.g. be a door or window of a vehicle, e.g. a recreational vehicle such as a caravan or camper. The insect screen assembly can be sized and/or shaped to cover the entire door opening or window opening. The insect screen assembly can be sized and/or shaped to shield a living area such as a bed, chair and/or table.

The insect screen assembly 1 includes an assembly frame 2. Here the assembly frame 2 includes four frame members 4. The frame members 4 can be extruded profiles, e.g. of plastics or aluminum. In this example the frame members 4 are mutually connected via corner pieces 6. The insect screen assembly 1 further includes a movable beam 8. The movable beam 8 is movable with respect to the assembly frame 2. In this example the top and bottom frame members 4 act as guides for guiding movement of the movable beam 8 in the direction of arrows B1 and B2. The insect screen assembly 1 further includes a screen 10. The screen 10 is connected to the movable beam 8 at a first side 12 thereof. The screen 10 is connected to the assembly frame 2 at a first side 14 thereof. The screen can include a mounting strip that is inserted into a mounting groove of the left frame member 4. When the movable beam 8 is moved in the direction of arrow B1 the screen 10 is extended over the door or window opening. Thus, the screen 10 closes off the door or window opening. When the movable beam 8 is positioned adjacent a second side 16 of the assembly frame 2 the door or window opening is fully closed by the screen 10, and the movable beam can be said to be in the closed position. When the movable beam 8 is moved in the direction of arrow B2 the screen 10 is compacted. When the movable beam 8 is positioned adjacent the first side 14 of the assembly frame 2 the door or window opening is fully released by the screen 10, and the movable beam can be said to be in the open position.

In this example, the screen 10 is a honeycomb screen. FIG. 1B shows a schematic view of the honeycomb screen 10. The honeycomb screen includes a first screen 18 and a second screen 20. Here the first and second screens 18, 20 are pleated. The first and second screens 18, 20 extend substantially along parallel planes. The first screen 18 and the second screen 20 are connected via transverse sheets 22. In FIG. 1B a plurality of transverse sheets 22 can be identified. The honeycomb screen 10 includes cells 24 formed between the first screen 18, the second screen 20 and two adjacent transverse sheets 22. Here the cells 24 are substantially tubular cells. Hence, the honeycomb screen 10 in this example includes a single row of substantially tubular cells 24.

The first sheet 18 in this example is made of a mesh material. The second sheet 20 in this example is made of a mesh material. The mesh material can e.g. be a metal mesh material and/or a polymeric mesh material. It will be appreciated that the transverse sheets can be made of mesh material. Alternatively, the transverse sheets can be made of a sheet material, a woven, non-woven, etc.

In this example the insect screen assembly 1 includes two opposed guides 26 for guiding the movable beam 8. The opposed guides 26 allow for sliding movement of the movable beam 8. In this example the insect screen assembly 1 also includes cords. The cords extend through the movable beam 8 in a so-called H-configuration. A first cord 28 extends from the top left corner of the insect screen assembly 1 to the top of the movable beam 8, through the movable beam to the bottom of the movable beam, and from the bottom of the movable beam 8 to the lower right corner of the insect screen assembly 1. A second cord 30 extends from the bottom left corner of the insect screen assembly 1 to the bottom of the movable beam 8, through the movable beam to the top of the movable beam, and from the top of the movable beam 8 to the upper right corner of the insect screen assembly 1. The cords 28, 30 in the H-configuration aid in maintaining the movable beam 8 aligned orthogonal to the opposed guides 26.

It will be appreciated that the insect screen assembly 1 may also include a second movable beam 8′ as e.g. shown in FIG. 1C. In the example of FIG. 1C the honeycomb screen 10 is connected to both movable beams 8, 8′, in between the two movable beams. It will be appreciated that the honeycomb screen 10 can include the ribs 34. It will be clear that instead of the honeycomb screen 10 another type of screen, such as a pleated screen, or a covering, such as a shade, e.g. a honeycomb shade, or a blackout, e.g. a honeycomb blackout, can be mounted between the movable beams 8, 8′.

Alternatively, or additionally, the second movable beam 8′, may e.g. be connected to a shade at a second side of the second movable beam. The shade may be connected to the assembly frame 2 at a second side thereof. The second movable beam may also have associated cords 28′, 30′ in a H-configuration. When the second movable beam is moved in the direction of arrow B1′ the shade is compacted. The shade can also include, or be made of a honeycomb material. When the second movable beam is positioned adjacent the second side 16 of the assembly frame 2 the door or window opening is fully released by the shade, and the second movable beam can be said to be in the open position. It will be appreciated that using both the movable beam 8 and the second movable beam 8′ any combination of the window being (partly) uncovered, (partly) covered by the screen 10 and/or (partly) covered by the shade can be obtained. Alternatively, the screen 10 and the shade can be connected to opposite sides of the movable beam 8. Instead of a shade also a second screen, or a blackout can be used.

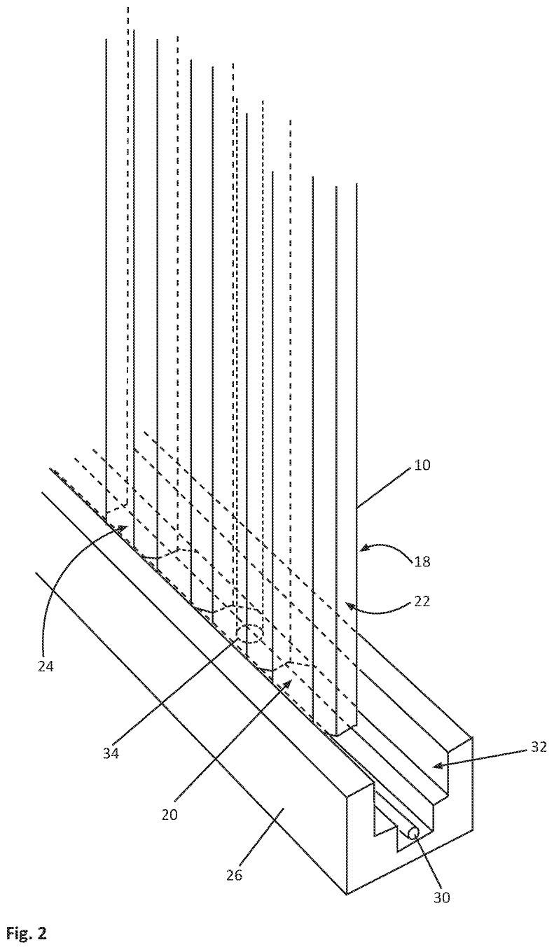

FIG. 2 shows a schematic partial view of an insect screen assembly 1, partially broken away. FIG. 2 shows part of the lower opposed guide 26. Here the guide includes a groove 32. The honeycomb screen 10 is partially inserted into the groove 32 so as to be guided in the groove 32. The movable beam 8 may also be partially inserted into the groove 32. Also, inserting the screen 10 into the groove 32 provides good sealing against insects. However, it will be appreciated that it is possible that the screen 10 is not inserted in the groove 32 at the lower guide 26. Gravity may sufficiently press the screen 32 against the lower guide 26 to provide proper sealing against insects. At the upper guide 26 gravity does not help, hence there the screen 10 is best inserted in the groove 32, or at least sealed against insects by a sealing lip on the outside or on the inside.

In this example the insect screen assembly 1 includes a plurality of ribs 34. The ribs 34 can be embodied as a tube (see FIG. 1B), a rod (see FIG. 2), a strip, a beam, an extrusion, or the like. In this example, the rib 34 is included in a cell 24 of the honeycomb screen 10. Hence, no fasteners for the rib are required. Once the rib 34 is inserted in the cell 24, and the honeycomb screen 10 is inserted in the assembly frame 2, e.g. in the groove 32, the rib will not escape.

According to an aspect a covering assembly can include a honeycomb covering having a plurality of, substantially, tubular cells, and one or more of the stiffening ribs. Such covering assembly is substantially as shown in FIG. 1B. The covering assembly can e.g. be hung in front of a window. The substantially tubular cells can e.g. extend substantially horizontally. As can be seen in FIG. 1B the one or more stiffening ribs are inserted in the substantially tubular cells. Hence, the stiffening ribs are easily incorporated in the assembly. Also in FIG. 1B at least one of the stiffening ribs is placed spaced away from an edge of the honeycomb covering. Here, at least one of the stiffening ribs is inserted in a substantially tubular cell that is spaced from the substantially tubular cells at the edge of the honeycomb covering. Hence, such stiffening rib provides stiffening of the honeycomb covering at a position spaced from the edge, e.g. near a center of the honeycomb covering. The covering can e.g. a shade and/or a blackout. The covering can also be a screen. However, when the screen is to be used as insect screen, a circumferential frame or other means for preventing insects from passing the screen, especially at a connection to the wall, are to be included in the assembly.

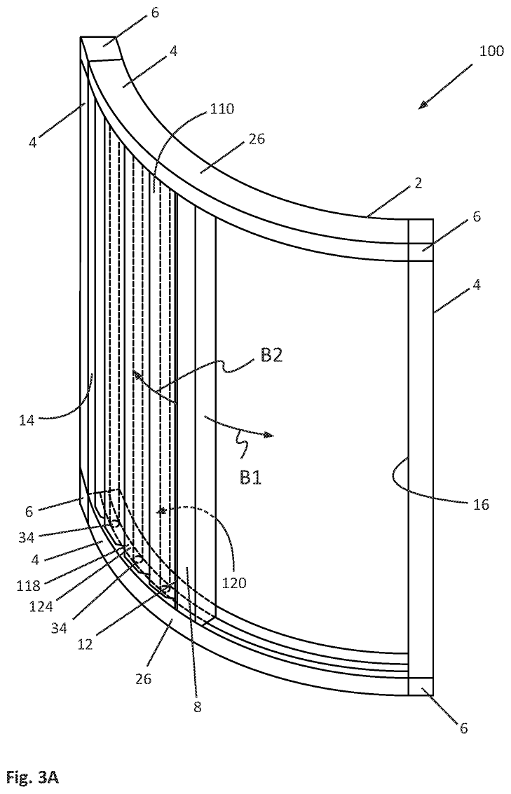

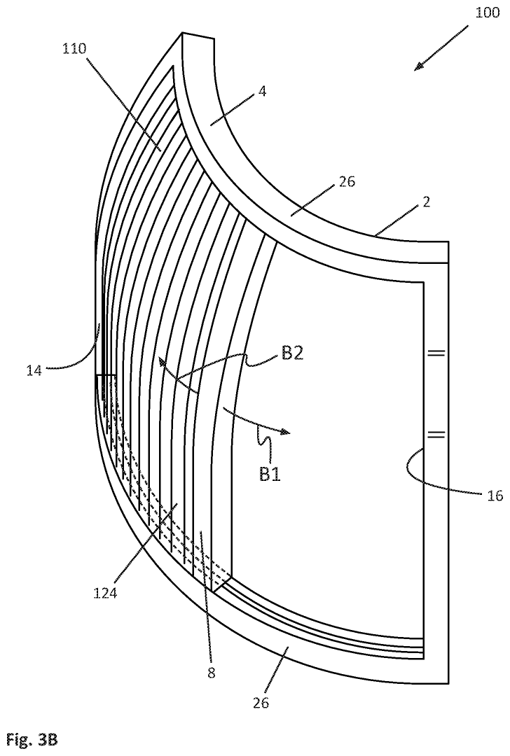

FIG. 3A shows a schematic representation of an example of a curved covering assembly 100, e.g. for a curved door frame or curved window frame of a vehicle. The curved covering assembly includes an assembly frame 2. In this example, the assembly frame 2 is a curved assembly frame 2. Here the assembly frame 2 includes four frame members 4. The frame members 4 can be extruded profiles, e.g. of plastics or aluminum. In this example the frame members 4 are mutually connected via corner pieces 6. The covering assembly 100 further includes a movable beam 8. The movable beam 8 is movable with respect to the assembly frame 2. In this example the top and bottom frame members 4 act as opposed guides 26 for guiding movement of the movable beam 8 in the direction of arrows B1 and B2. It will be clear that the covering assembly 100 may also include more than one movable beam, e.g. as described with respect to FIG. 1C.

It will be clear that in this example the two opposed guides 26 are curved. The opposed guides 26 are curved in a direction substantially orthogonal to a length direction of the movable beam. An axis (or axes) around which the opposed guides 26 forms a curve are substantially parallel to a length direction of the movable beam. Hence, the covering assembly 100 can be fit to a curved window or door.

The covering assembly 100 further includes a covering 110. The covering 110 is connected to the movable beam 8 at a first side 12 thereof. The covering 110 is connected to the assembly frame 2 at a first side 14 thereof. When the movable beam 8 is moved in the direction of arrow B1 the covering 110 is extended over the door or window opening. Thus, the covering 110 closes off the door or window opening. When the movable beam 8 is positioned adjacent a second side 16 of the assembly frame 2 the door or window opening is fully closed by the covering 110, and the movable beam can be said to be in the closed position. When the movable beam 8 is moved in the direction of arrow B2 the covering 110 is compacted. When the movable beam 8 is positioned adjacent the first side 14 of the assembly frame 2 the door or window opening is fully released by the covering 110, and the movable beam can be said to be in the open position.

In this example, the covering 110 is a honeycomb covering. The honeycomb covering includes a first sheet 118 and a second sheet 120. The first sheet 118 and the second sheet 120 are connected via transverse sheets 122. The honeycomb covering 110 includes cells 124 formed between the first sheet 118, the second sheet 120 and two adjacent transverse sheets 122. The honeycomb covering 110 can include, or be, a honeycomb shade. The honeycomb covering 110 can include, or be, a honeycomb screen. The honeycomb covering 110 can include, or be, a honeycomb blackout.

Here, ribs 34 are inserted in cells 124 of the honeycomb covering 110. In this example each cell 124 includes a rib 34. It will be appreciated that it is also possible that not each cell 124 includes a rib 34. For example, a rib can be inserted into every other cell, every third cell, every fourth cell, every fifth cell, or the like. Ribs can be distributed evenly along a width of the covering 110.

In this example the opposed guides 26 each include a groove 32. Here, the ribs 34 are inserted into the grooves 32. Hence, the covering 110 is guided along the two opposed guides when the movable beam is moved. Thus, the covering neatly follows the curved shape of the assembly frame. In this example the covering 110 is not guided in the groove 32. However, if desired the covering 110 may also be guided by the opposed guides.

FIG. 3B shows a schematic representation of an example of a curved covering assembly 100, e.g. for a curved door frame or curved window frame, e.g. of a vehicle, similar to the covering assembly described in relation to FIG. 3A. The curved covering assembly includes an assembly frame 2. In this example, the assembly frame 2 is a double curved assembly frame 2. The assembly frame is curved in two orthogonal directions. Here the assembly frame is curved both in horizontal direction and in vertical direction. Here the assembly frame 2 includes four frame members 4. The frame members 4 can be extruded profiles, e.g. of plastics or aluminum. In this example the frame members 4 are mutually connected via corner pieces 6. The covering assembly 100 further includes a movable beam 8. The movable beam 8 is movable with respect to the assembly frame 2. In this example the top and bottom frame members 4 act as opposed guides 26 for guiding movement of the movable beam 8 in the direction of arrows B1 and B2. It will be clear that the covering assembly 100 may also include more than one movable beam, e.g. as described with respect to FIG. 1C.

In this example the movable beam 8 is curved. In this example also the two opposed guides 26 are curved. Hence, the covering assembly 100 can be fit to a double curved window or door. The covering assembly can also be used free standing.

The covering assembly 100 further includes a covering 110. The covering 110 is connected to the movable beam 8 at a first side 12 thereof. The covering 110 is connected to the assembly frame 2 at a first side 14 thereof. When the movable beam 8 is moved in the direction of arrow B1 the covering 110 is extended over the door or window opening. Thus, the covering 110 closes off the door or window opening. When the movable beam 8 is positioned adjacent a second side 16 of the assembly frame 2 the door or window opening is fully closed by the covering 110, and the movable beam can be said to be in the closed position. When the movable beam 8 is moved in the direction of arrow B2 the covering 110 is compacted. When the movable beam 8 is positioned adjacent the first side 14 of the assembly frame 2 the door or window opening is fully released by the covering 110, and the movable beam can be said to be in the open position.

In this example, the covering 110 is a honeycomb covering. The honeycomb covering 110 includes cells 124. The honeycomb covering 110 can include, or be, a honeycomb shade. The honeycomb covering 110 can include, or be, a honeycomb screen. The honeycomb covering 110 can include, or be, a honeycomb blackout.

Here, ribs 34 are inserted in cells 124 of the honeycomb covering 110. In this example each cell 124 includes a rib 34. It will be appreciated that it is also possible that not each cell 124 includes a rib 34. For example, a rib can be inserted into every other cell, every third cell, every fourth cell, every fifth cell, or the like. Ribs can be distributed evenly along a width of the covering 110. Here the ribs 34 are curved to follow and support the curve of the covering 110. The ribs can be attached to the covering to prevent rotating of the ribs. Alternatively, or additionally, the ribs are sized and/or shaped such that rotation of the rib in the cell is prevented. Alternatively, or additionally, the ribs can be guided in at least one of the opposed guides 26 such that rotation of the rib is prevented.

In this example the opposed guides 26 each include a groove 32. Here, the ribs 34 are inserted into the grooves 32. Hence, the covering 110 is guided along the two opposed guides when the movable beam is moved. Thus, the covering neatly follows the curved shape of the assembly frame. In this example the covering 110 is not guided in the groove 32. However, if desired the covering 110 may also be guided by the opposed guides.

In this example, the covering 110 is a honeycomb covering. It will be appreciated that the double curved covering, such as a double curved insect screen can also be made with other coverings, such as a pleated covering. The pleated covering can also be provided with curved stiffening ribs.

In this example the covering assembly is double curved. It will be appreciated that the curved movable beam 8 can also be used in a single curved covering assembly. Then an axis (or axes) around which the covering 110 forms a curve can be substantially parallel to a movement direction of the movable beam.

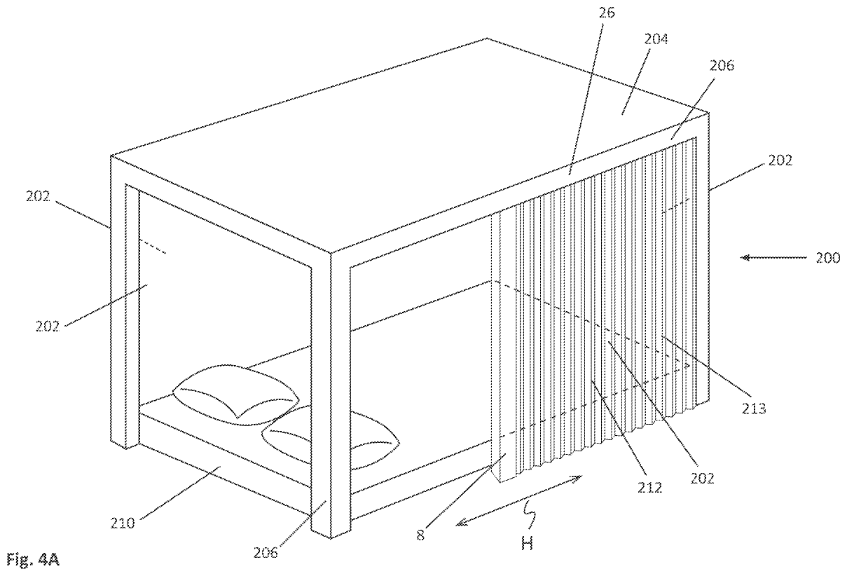

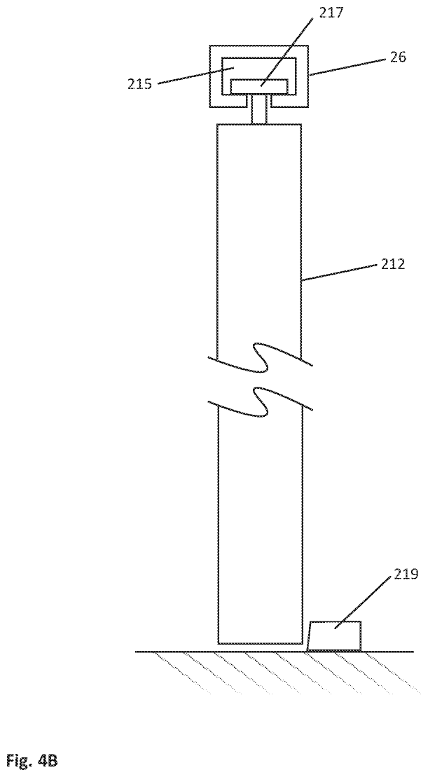

FIG. 4A shows an example of an insect screen unit 200. In this example, the insect screen unit includes four walls 202 and a roof 204. Here the walls 202 and the roof 204 include an insect screen. Here the walls 202 and the roof are made of an insect screen material, such as a mesh material. The walls 202 and the roof 204 are connected via a frame 206. The frame 206 can e.g. include metal, such as aluminium, or plastic frame members. In this example, the frame 206 is sized to be large enough to include a bed 210, here a double bed. Hence, the insect screen unit 200 forms a structure that can include the bed 210, and can shield the bed from insects. In this example, the insect screen unit is arranged to form a free-standing structure that can be placed anywhere in a space. It is also possible that the insect screen unit is arranged to be positioned against, or attached to, one or more walls of a room. It will be appreciated that in case the insect screen unit is arranged to be positioned against a wall, the corresponding wall 202 of the insect screen unit can be omitted.

In this example, one of the walls 202 includes a door 212. Here the door is constructed similar to the insect screen assembly 1 described with respect to FIG. 1A. It will be appreciated that the door may also be constructed similar to the assembly described with respect to FIG. 1C. In this example the door 212 can be opened and closed by movement in a horizontal direction H. In this example, the door 212 includes a pleated screen 213. The pleated screen 213 does not necessitate the use of a bottom guide. Nevertheless, the presence of the bottom guide 26 can increase the rigidity of the insect screen unit 200.

FIG. 4B shows an example where the door 212 is suspended from a top guide 26, without a bottom guide being present. In this example, the door 212 is suspended in a generally C-shaped groove 215 of the upper guide 26. Thereto the door 212 includes a runner 217. The runner can be connected to the screen 213. The runner can also be connected to ribs 34 attached to the screen 213. In this example, a threshold 219 is positioned at the floor. The threshold 219 can aid in guiding the screen. Also, the threshold 219 can aid in sealing against insects. The threshold can be mounted to the floor e.g. by means of an adhesive or fasteners.

Here the pleated screen is attached to a movable beam 8. Cords may extend through the pleated screen for guiding and/or stiffening the screen. It will be appreciated that alternatively, the door may also include a honeycomb screen 10, or a roll-up screen. The honeycomb screen can include one or more ribs 34, e.g. inserted into cells of the screen. Here too, the ribs 34 may be attached to the honeycomb screen. The ribs may include the runner 217 for guiding the screen.

In this example, the remaining walls 202 do not include doors. Hence, these walls need not be openable. Therefore, these walls can be constructed of single ply, straight insect screen if desired. If additional strength is desired, the remaining walls can include pleated screen and/or honeycomb screen. Similarly, the roof 204 can include, or be, straight, pleated or honeycomb screen.

For this and the following examples it follows that the straight screen, roll-up screen, pleated screen and/or honeycomb screen may be provided with stiffening ribs for increasing stiffness. Alternatively, or additionally, the straight screen, pleated screen and/or honeycomb screen may be provided with cords, such as tensioning cords, for increasing stiffness.

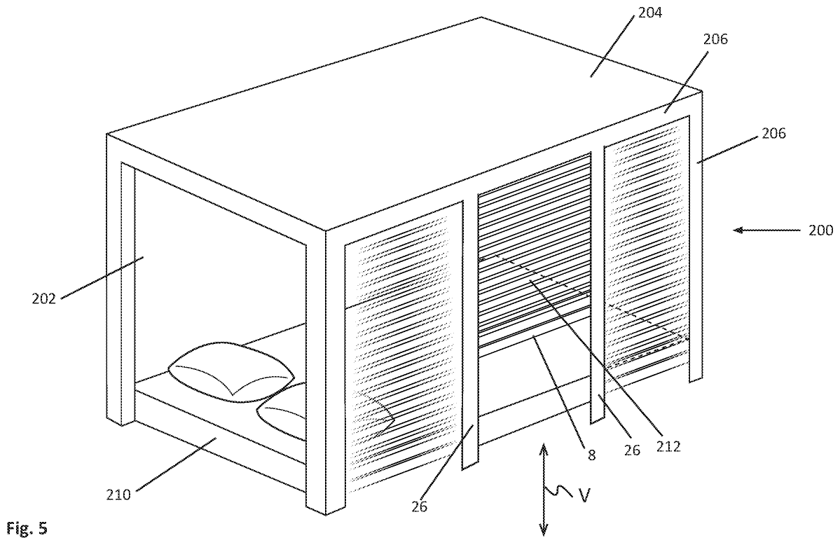

FIG. 5 shows an example of an insect screen unit 200. In this example, the insect screen unit includes four walls 202 and a roof 204. Here the walls 202 and the roof 204 include an insect screen. Here the walls 202 and the roof are made of an insect screen material, such as a mesh material. The walls 202 and the roof 204 are connected via a frame 206. The frame 206 can e.g. include metal, such as aluminium, or plastic frame members. In this example, the frame 206 is sized to be large enough to include a bed 210, here a double bed. Hence, the insect screen unit 200 forms a structure that can include the bed 210, and can shield the bed from insects. In this example, the insect screen unit is arranged to form a free-standing structure that can be placed anywhere in a space. It is also possible that the insect screen unit is arranged to be positioned against, or attached to, one or more walls of a room. It will be appreciated that in case the insect screen unit is arranged to be positioned against a wall, the corresponding wall 202 of the insect screen unit can be omitted.

In this example, one of the walls 202 includes a door 212. Here the door is constructed similar to the insect screen assembly 1 described with respect to FIG. 1A. It will be appreciated that the door may also be constructed similar to the assembly described with respect to FIG. 1C. In this example the door 212 can be opened and closed by movement in a vertical direction V. In this example, the door 212 includes a pleated screen 213. Here the pleated screen is attached to a movable beam 8. It will be appreciated that alternatively, the door may also include a honeycomb screen 10, or a roll-up screen.

In this example, the remaining walls 202 do not include doors. Hence, these walls need not be openable. Therefore, these walls can be constructed of single ply, straight insect screen if desired. If additional strength is desired, the remaining walls can include pleated screen and/or honeycomb screen. Similarly, the roof 204 can include, or be, straight, pleated or honeycomb screen.

FIG. 6 shows an example of an insect screen unit 200. In this example the insect screen unit 200 is placed in a corner of a room against, e.g. mounted to, two walls 203a, 203b of the room. In this example, the insect screen unit 200 includes two walls 202a, 202b. It will be appreciated that the larger wall 202a simultaneously forms the roof of the insect screen unit 200 in this example. Here the walls 202a, 202b include an insect screen. Here the walls 202a, 202b are made of an insect screen material, such as a mesh material. The walls 202a, 202b are connected via a frame 206. The frame 206 can e.g. include metal, such as aluminium, or plastic frame members. In this example, the frame 206 is sized to be large enough to include a bed 210, here a single bed. Hence, the insect screen unit 200 forms a structure that can include the bed 210, and can shield the bed from insects.

In this example, the wall 202a forms a door 212. Here the door is constructed similar to the assembly 100 described with respect to FIG. 3. In this example the door 212 can be opened and closed by movement in a vertical direction V. In this example, the door 212 includes a honeycomb screen 10. Here the honeycomb screen 10 is attached to a movable beam 8. In this example, the door 212 includes a plurality of ribs 34 as described with respect to FIG. 3.

In this example, the remaining wall 202b does not include a door. Hence, this wall need not be openable. Therefore, this walls can be constructed of single ply, straight insect screen if desired. If additional strength is desired, the remaining wall can include pleated screen and/or honeycomb screen.

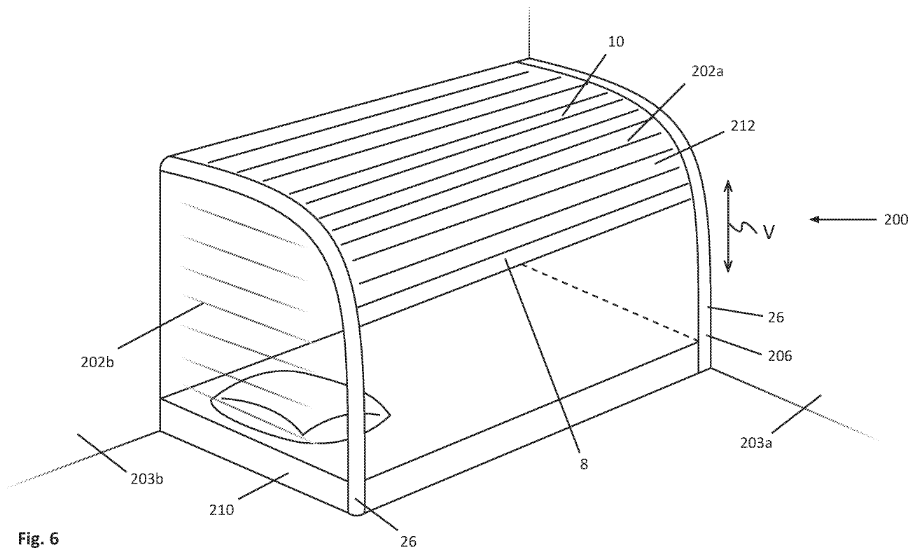

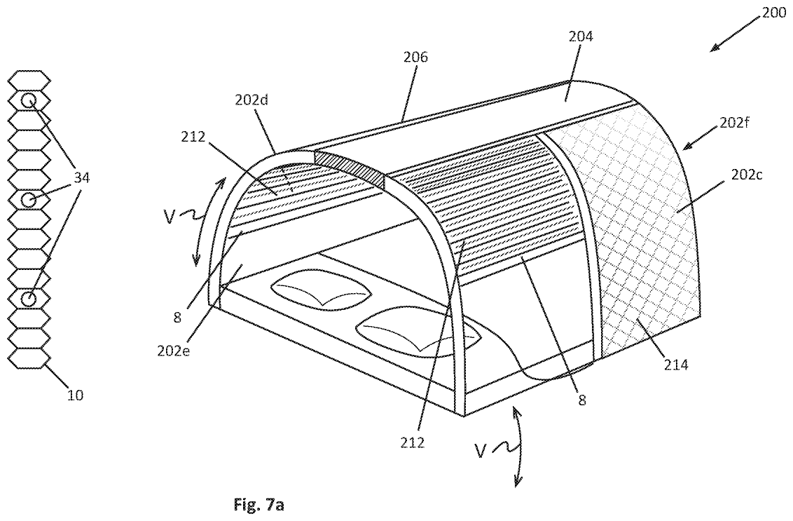

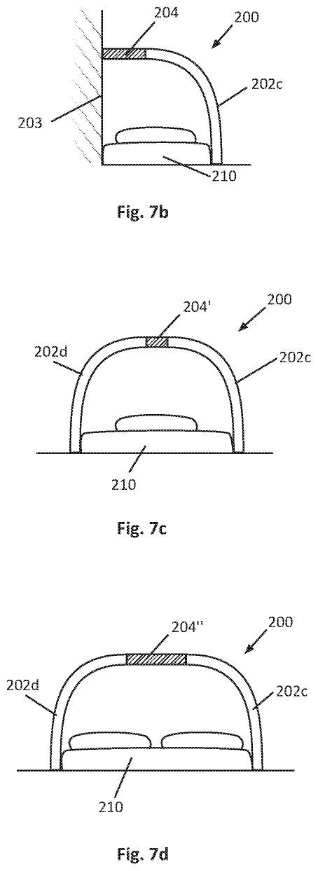

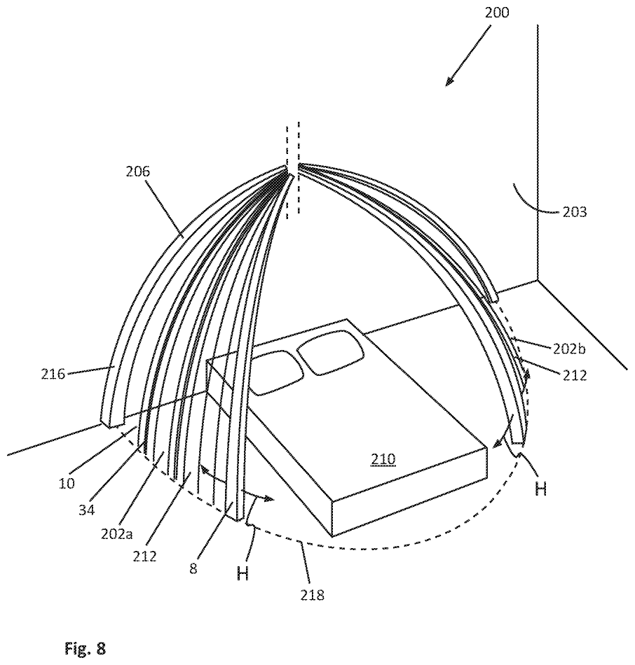

FIG. 7a shows an example of an insect screen unit 200. In this example, the insect screen unit is arranged to form a free-standing structure that can be placed anywhere in a space In this example, the insect screen unit 200 includes two curved walls 202c, 202d and a roof 204. The insect screen unit 200 further includes a front wall 202e and a rear wall 202f. Here the walls 202c, 202d, 202e, 202f and the roof 204 include an insect screen. The walls 202c, 202d, 202e, 202f and the roof 204 are connected via a frame 206. The frame 206 can e.g. include metal, such as aluminium, or plastic frame members. In this example, the frame 206 is sized to be large enough to include a bed 210, here a double bed. Hence, the insect screen unit 200 forms a structure that can include the bed 210, and can shield the bed from insects.

In this example, both curved walls 202c, 202d include a door 212. Here the doors are constructed similar to the assembly 100 described with respect to FIG. 3. In this example the doors 212 can be opened and closed by movement in a vertical direction V. In this example, the doors 212 each includes a honeycomb screen 10. Here the honeycomb screens 10 are attached to a movable beams 8. In this example, the doors 212 each include a plurality of ribs 34 as described with respect to FIG. 3.

In this example, part 214 of the curved walls 202c, 202d does not include a door. Hence, this part 214 need not be openable. Therefore, this part can be constructed of single ply, straight insect screen if desired. However, to accommodate the curved shape, ribs may be required. The part 214 can also include pleated screen and/or honeycomb screen.

The insect screen unit 200 shown in FIG. 7a can have a modular structure. The curved walls 202c, 202d and the roof can be matched to purpose. For example, FIG. 7b shows an example of an insect screen unit 200 which only includes one curved wall 202c and a roof 204. This insect screen unit 200 is arranged for being positioned against a wall 203. FIG. 7c shows an example of an insect screen unit 200 which includes two curved wall 202c, 202d and a narrow roof 204′. This insect screen unit 200 is arranged for being freestanding, and including a single bed. FIG. 7d shows an example of an insect screen unit 200 which includes two curved wall 202c, 202d and a wide roof 204″. This insect screen unit 200 is arranged for being freestanding, and including a king size double bed.

FIG. 8 shows an example of an insect screen unit 200. In this example the insect screen unit 200 is placed against, e.g. mounted to, a wall 203 of a room. In this example, the insect screen unit 200 includes two walls 202a, 202b. Here the walls 202a, 202b include an insect screen. Here the walls 202a, 202b are made of an insect screen material, such as a mesh material. The walls 202a, 202b are connected via a frame 206. The frame 206 can e.g. include metal, such as aluminium, or plastic frame members. In this example, the frame 206 is sized to be large enough to include a bed 210, here a double bed. Hence, the insect screen unit 200 forms a structure that can include the bed 210, and can shield the bed from insects.

In this example, each of the walls 202a 202b forms a door 212. Here the insect screen unit 200 includes two mirror-symmetric doors 212. In this example the doors 212 can be opened and closed by movement in a horizontal direction H. In this example, the doors 212 includes a honeycomb screen 10. However an other material can be used, e.g. a pleated screen Here the honeycomb screen 10 is attached to a movable beam 8. In this example, the door 212 includes a plurality of ribs 34.

Here the frame 206 includes a first arched segment, here circle segment, 216. The first arched segment is mounted to the wall 203. To the first arched segment 216 the movable beam 8 is hingedly connected. The movable beam 8 forms a second arched segment, here circle segment. The movable beam can be hingedly moved to close the insect screen unit. In this example the movable beam follows a circle segment path 218 on the floor of the room. If desired, a guide 26 may be placed on the floor.

Here the insect screen unit 200 includes two mirror-symmetric doors 212. It will be appreciated that the insect screen unit 200 can also include only one of the doors 212. The movable beam can then follow a semi-circular path on the floor or guide 26. When the insect screen unit 200 is placed in a corner of a room, the single door 212 can follow a quarter-circle path.

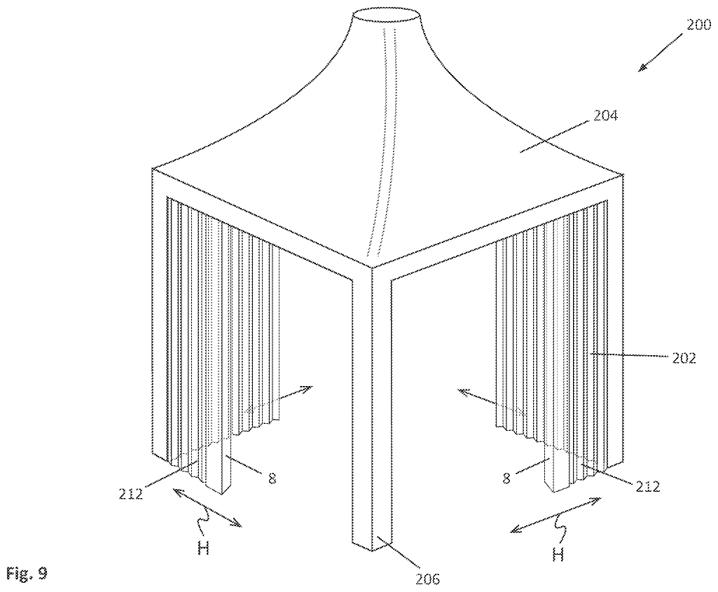

FIG. 9 shows an example of an insect screen unit 200. In this example, the insect screen unit includes four walls 202 and a roof 204. Here the walls 202 include an insect screen. Here the walls 202 are made of an insect screen material, such as a mesh material. In this example, the roof 204 includes a cloth, such as tent cloth, or a water impermeable cloth or sheet. The walls 202 and the roof 204 are connected via a frame 206. The frame 206 can e.g. include metal, such as aluminium, or plastic frame members. In this example, the frame 206 is sized to be large enough to include a table and a number of chairs. Hence, the insect screen unit 200 forms a structure that can include the table and chairs, and can shield the table and chairs from insects. In this example, the insect screen unit is arranged to form a free-standing structure that can be placed anywhere in a space, such as a garden. It is also possible that the insect screen unit is arranged to be positioned against, or attached to, one or more walls of a building, such as a house. The insect screen unit can e.g. be positioned against, or attached, to a wall of a building and surround a door in said building wall. It will be appreciated that in case the insect screen unit is arranged to be positioned against a wall, the corresponding wall 202 of the insect screen unit can be omitted.

In this example, each of the walls 202 includes a door 212. Here the door is constructed similar to the insect screen assembly 1 described with respect to FIG. 1A. It will be appreciated that the door may also be constructed similar to the assembly 1 described with respect to FIG. 1C or the assembly 100 as described with respect to FIG. 3. In this example the door 212 can be opened and closed by movement in a horizontal direction H.

In this example, the door 212 includes a pleated screen 213. The pleated screen 213 does not necessitate the use of a bottom guide. Nevertheless, the presence of the bottom guide 26 can increase the rigidity of the insect screen unit 200. Here the pleated screen is attached to a movable beam 8. It will be appreciated that alternatively, the door may also include a honeycomb screen 10, or a roll-up screen.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

In the examples, the door or window frame and the assembly frame are substantially rectangular. However, it is also possible that one or more of the frame members is slanted. It is also possible that one or more of the frame members is curved.

The examples of FIGS. 1A, 1B and 2 relate to an insect screen assembly. It will be appreciated that similarly a door covering assembly or window covering assembly can be provided in which the insect screen 10 is replaced by a shade or blackout. The honeycomb screen can e.g. be replaced by a honeycomb shade or honeycomb blackout. The honeycomb shade can include a first sheet and a second sheet, connected via a plurality of transverse sheets. The honeycomb blackout can include a first sheet and a second sheet, connected via a plurality of transverse sheets.

In the example of FIG. 3A the ribs are guided in the grooves of the opposed guides. It will be appreciate that other guiding principles are possible. The opposed guides can e.g., for example each, include a rail onto which the rib is guided. It will be clear that the two opposed guides may have different guiding features.

In the examples the opposed guides guide the movable beam and the screen/shade/blackout and/or the ribs. It will be appreciated that separate guides may be provided for guiding the movable beam, and for guiding the screen/shade/blackout and optionally the ribs. It will be appreciated that separate guides may be provided for guiding the screen/shade/blackout and for guiding the ribs.

It will be appreciated that in any of the examples, a first covering may be attached to the first side of the movable beam, and a second covering may be attached to the second side of the movable beam. Such covering assembly can include a screen and a shade, or a screen and a blackout, or a shade and a blackout. It is also possible that the covering assembly includes two screens or two shades or two blackouts. The two screens can e.g. have a different mesh size, transparency, translucency, color, pattern or texture. The two shades can e.g. have a different transparency, translucency, color, pattern or texture. The two blackouts can e.g. have a different color, pattern or texture.

Similarly, in any of the examples two or more movable beams can be used. a first covering may be attached to a first movable beam, and a second covering may be attached to a second movable beam. Such covering assembly can include a screen and/or a shade and/or a blackout. It is also possible that the covering assembly includes two screens and/or two shades and/or two blackouts. The two screens can e.g. have a different mesh size, transparency, translucency, color, pattern or texture. The two shades can e.g. have a different transparency, translucency, color, pattern or texture. It is also possible that a screen, shade or blackout is connected to two adjacent movable beams, between the two movable beams. In such case a screen, shade or blackout may be connected to the other side of one or both of said two movable beams.

In the examples the movable beam is arranged for movement in horizontal direction. It will be appreciated that it is also possible that the movable beam is arranged for movement in other directions, such as vertical direction.

Herein the term honeycomb screen, or honeycomb covering, generally refers to a cellular screen, or cellular covering. In the examples, the honeycomb structure includes an first sheet, an second sheet and a plurality of transverse sheets connecting the first and the second sheets, forming a single row of tubular cells. However, other honeycomb structures can also be applied. For example honeycomb structures can be used including a first sheet and a second sheet attached to each other at spaced distances to form a single row of tubular cells. Honeycomb structures can be used in which each substantially tubular screen is made from a separate sheet. Honeycomb structures can be used in which sub-units of two or more substantially tubular screens are made from a separate sheet. Also, honeycomb structures can be used having two or more rows of tubular cells. Also, honeycomb structures can be used having one or more rows of tubular cells, being made of sheets extending in a thickness direction of the honeycomb structure. Also honeycomb structures can be used in which an outer sheet is different from an inner sheet.

In the examples of FIGS. 4A-8 the walls and roof include insect screen and/or are made of insect screen. It is also possible that one or more of the walls include a shade and/or blackout. For example, in the example of FIG. 9 the roof does not include an insect screen, although this is not ruled out. In the examples of FIGS. 4A-9 the door(s) includes insect screen. It is also possible that the door includes a sheet, shade and/or blackout.

In the examples of FIGS. 4A-9 the door is formed by an insect screen assembly. It is also possible that the door is formed by a covering assembly.

It will be appreciated that in any of the examples of FIGS. 4A-9 any wall can be made of, or include, a screen, a sheet (e.g. a transparent sheet), a watertight sheet, a shade and/or a blackout, or combinations thereof. The examples of FIGS. 4A-9 therefore also relate to an enclosing unit, not necessarily being an insect screen unit.

It will be clear that the insect screen unit or enclosing unit can additionally include a window, e.g. as described herein.

In the examples frame members are mutually connected via a corner piece. It will be appreciated that the frame members can also be arranged such that no corner piece is required.

However, other modifications, variations, and alternatives are also possible. The specifications, drawings and examples are, accordingly, to be regarded in an illustrative sense rather than in a restrictive sense.

For the purpose of clarity and a concise description features are described herein as part of the same or separate embodiments, however, it will be appreciated that the scope of the invention may include embodiments having combinations of all or some of the features described. In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. An insect screen assembly for a door or a window, including:
an assembly frame;
at least one movable beam, movable with respect to the assembly frame;
a screen connected to the at least one movable beam, so as to be moved between a first and a second position;
wherein the screen includes a honeycomb screen;
one or more stiffening ribs,
wherein the covering assembly is free from cords extending through the screen.

2-12. (canceled)

13. An insect screen unit including one or more walls for forming a closed enclosure, at least one of the walls including a screen door including:
an assembly frame;
at least one movable beam, movable with respect to the assembly frame;
a screen connected to the at least one movable beam, so as to be moved betweena first and a second position.

14. The insect screen unit according to claim 13, wherein the screen includes a honeycomb screen.

15. The insect screen unit according to claim 13, wherein the assembly frame includes one guide, or two opposed guides, wherein the one guide or one of the two opposed guides or each of the two opposed guides is arranged for guiding the screen.

16. (canceled)

17. The insect screen unit according any one of claims to claim 13, including one or more cords for stiffening the screen.

18. The insect screen unit according to claim 13, free from cords extending through through holes in a surface of the screen.

19. The insect screen unit according to claim 13, including one or more stiffening ribs for stiffening the screen.

20. The insect screen unit according to claim 14, including one or more stiffening ribs for stiffening the screen, wherein the one or more stiffening ribs are inserted in cells of the screen.

21. The insect screen unit according to claim 15, wherein one or more stiffening ribs are guided by the one guide or at least one of the two opposed guides.

22. The insect screen unit according to claim 13. wherein the screen door is curved.

23. The insect screen unit according to claim 13. wherein the screen door is double curved.

24. The insect screen unit according to claim 13, wherein the one or more walls are arranged for forming the closed enclosure by themselves or in cooperation with one or more pre-existing walls.

25. An enclosing unit including one or more walls for forming a closed enclosure, at least one of the walls including a door including:
an assembly frame;
at least one movable beam, movable with respect to the assembly frame;
a sheet connected to the at least one movable beam, so as to be moved between a first and a second position.

26. A covering assembly, for a door or window, including:
an assembly frame;
at least one movable beam, movable with respect to the assembly frame;
a covering connected to the at least one movable beam, so as to be moved between a first and a second position;
wherein the covering includes a honeycomb covering; and
one or more stiffening ribs,
wherein the covering assembly is free from cords extending through the covering.

27. The covering assembly according to claim 26, wherein the assembly frame includes one guide, or two opposed guides, wherein one of the two opposed guides or each of the two opposed guides is arranged for guiding the covering.

28-31. (canceled)

32. The covering assembly according to claim 26, wherein the one or more stiffening ribs are inserted in cells of the honeycomb covering.

33. The covering assembly according to claim 27, wherein the one or more stiffening ribs are guided by the one guide or at least one of the two opposed guides,

34. The covering assembly according to claim 27, wherein the one guide or at least one of the two opposed guides is curved.

35. The covering assembly according to claim 26, wherein the at least one movable beam is curved.

36. The covering assembly according to claim 26. wherein the covering includes a honeycomb insect screen.

37. The covering assembly according to claim 26, wherein the covering includes a honeycomb shade.

38. The covering assembly according to claim 26, including a honeycomb insect screen connected to a first side of the moveable beam, and a honeycomb shade connected to a second side of the moveable beam.

39-56. (canceled)
